(19) United States
(12) Patent Application Publication
(10) Pub. No.: US 2007/0142527 A1
(43) Pub. Date: Jun. 21, 2007

(54) Composition containing a synthetic resin and a filler, methods for producing the composition and films obtained from this composition

(75) Inventors: Roberto Rosa, Ranco (IT); Yves Vanderveken, Heverlee (BE); Karine Cavalier, Arles (FR); Didier Sy, Salin de Giraud (FR); Christophe Fringant, Peseux (FR); Josselin Bobet, Sain Bel (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: SOLVAY (SOCIETE ANONYME), Brussels (BE)

(21) Appl. No.: 10/579,095

(22) PCT Filed: Nov. 12, 2004
(86) PCT No.: PCT/EP04/52953

§ 371 Date: May 12, 2006

(30) Foreign Application Priority Data
Nov. 14, 2003 (FR) 03 13349

(51) Int. Cl. C08K 3/26

(52) U.S. Cl. 524/425; 524/568; 524/563; 524/571; 524/555; 524/556

(57) ABSTRACT

Composition containing (a) a synthetic resin and (b) a filler, the filler containing (b1) at least one inorganic substance having a specific surface area higher than or equal to 15 m²/g and (b2) at least one surface-active agent and/or one coating agent. Method for producing the composition. Use of the composition for the production of films, and films obtained starting with this composition.

The invention relates to compositions containing synthetic resins.

It relates more particularly to compositions containing at least one synthetic resin and at least one filler.

The packaging industry makes intensive use of synthetic resins, especially thermoplastic resins in the form of thin films.

A technique commonly used for producing sheets of thermoplastic resin consists of polymerizing a monomer in an aqueous phase, of isolating the solid resulting from polymerization and of subjecting the collected resin to a blown-film extrusion process. This technique is in particular applied for the production, for example, of thin films made of polyvinylidene chloride, intended for packaging food materials. Thin polyvinylidene chloride films have in point of fact the advantage of having low permeability to gases, especially to oxygen in the ambient air, which is favourable for good preservation of food. They additionally possess properties that are indispensable for the handling and sale of food, such as high flexibility and good mechanical strength.

In order to improve certain properties of polyvinylidene chloride films, it is known to incorporate mineral fillers in these such as calcium carbonate.

Thus, in International Application WO 96/22329, a calcium carbonate powder is added to an emulsion of a polymer before the latter is coagulated to form the resin. This known method is however difficult to put into practice. It does not in particular allow a uniform distribution of calcium carbonate particles to be obtained in the emulsion, these particles being preferentially adsorbed on small polymer droplets to the detriment of larger droplets. The properties of the resin obtained from the method are consequently heterogeneous, which has harmful repercussions on the subsequent extrusion of the resin.

The current problem is therefore to provide compositions having the required properties for producing thin films intended for food packaging, namely good thermal stability and low oxygen permeability.

Special compositions have now been found that simultaneously have these properties.

The object of the invention is therefore to provide an improved composition that has an optimum ability to produce thin films having good thermal resistance and good oxygen-barrier properties, preferably by the blown-film extrusion technique.

Consequently, the invention relates to a composition containing:
(a) at least one synthetic resin selected from homopolymers and copolymers of ethylene, propylene, styrene, vinyl chloride, vinylidene chloride, acrylic acid, alkyl acrylates, methacrylic acid, alkyl methacrylates, acrylonitrile, vinyl acetate, vinyl alcohol, isoprene, chloroprene, vinyl fluoride, vinylidene fluoride, tetrafluoroethylene, copolymers of ethylene and alpha-olefins, copolymers of propylene and alpha-olefins other than propylene, copolymers of vinylidene chloride and vinyl chloride, copolymers of vinylidene chloride and alkyl acrylates, copolymers of vinylidene chloride and alkyl methacrylates, copolymers of styrene, butadiene and rubber, copolymers of acrylonitrile and butadiene, copolymers of styrene and acrylonitrile, copolymers of acrylonitrile, butadiene and styrene, copolymers of vinylidene fluoride and hexafluoropropylene, polyesters, polyamides, polyurethanes, polycarbonates, polyphenylene ethers, polyimides, polyamide imides, polybenzimidazoles, polyalkylene oxides, polyetherether ketones, polyether sulfones, polyisocyanates, polyphenylene sulfides, and
(b) at least one filler containing (b1) at least one inorganic substance having a specific surface area higher than or equal to 15 m²/g and (b2) at least one surface-active agent and/or at least one coating agent.

In the composition according to the invention, the synthetic resin is a polymeric resin. The expression polymer is used as is generally accepted, and invariably denotes a homopolymer, a copolymer or a blend of homopolymers and/or copolymers. The expressions “synthetic resins”, “polymeric resins”, “resins” and “polymers” will be used hereinafter to denote the same compound. Polymers based on vinyl chloride, vinylidene chloride, acrylic acid and its esters, methacrylic acid and its esters, are preferred. Copolymers based on vinylidene chloride and vinyl chloride and copolymers based on vinylidene chloride and methyl acrylate are more particularly preferred. The vinylidene content of copolymers based on vinylidene chloride and vinyl chloride is generally higher than or equal to 40% by weight, preferably higher than or equal to 45% by weight and more specifically higher than or equal to 70% by weight This content is usually lower than or equal to 95% by weight and is advantageously lower than or equal to 90% by weight. Values lower than or equal to 85% by weight are particularly suitable. The vinylidene content of copolymers based on vinylidene chloride and methyl acrylate is generally higher than or equal to 60% by weight, preferably higher than or equal to 65% by weight and more specifically higher than or equal to 75% by weight. This content is usually lower than or equal to 99% by weight and is advantageously lower than or equal to 95% by weight. Values lower than or equal to 92% by weight are particularly suitable. Copolymers based on vinylidene chloride and maleic anhydride or itaconic acid may also be suitable.

Synthetic resins participating in the composition according to the invention can be obtained by any known polymerization method, such as aqueous emulsion polymerization, aqueous suspension polymerization, solution polymerization or melt polymerization. Aqueous suspension polymerization and aqueous emulsion polymerization are preferred. Aqueous emulsion polymerization is more particularly preferred. Among the various polymerization procedures, radical polymerization and controlled radical polymerization procedures in the presence of halogenated derivatives or derivatives of the xanthate type are preferred.

The emulsion polymerization technique is a well-known technique in the sector of the production of polymers (PVDC and vinylidene chloride copolymers, Techniques de l'Ingénieur, Traité Génie des procédés, J. 6570). It is commonly used for producing vinyl polymers, especially polyvinyl chloride, polyvinylidene chloride and copolymers of vinyl chloride and vinylidene chloride. An aqueous polymer emulsion used in this technique denotes an emulsion of the said polymer in water or an aqueous solution. The emulsion can contain additives commonly used in the production of polymers by the emulsion polymerization technique. Additives commonly used comprise stabilizers, surface-active agents, polymerization initiators and plasticizers. The resins can be isolated by any known technique, such as for example filtration, centrifuging, spraying and atomizing. These isolation steps can be preceded by a coagulation step. The technique of isolation preceded by a coagulation step is preferred.

The stability of the emulsion will depend on the diameter of the polymer particles. This diameter is linked to several parameters, in particular the polymer used, the polymerization initiator, the surface-active agents used, the temperature and stirring and the presence of co-solvents or additives in the water and the presence or otherwise of water-soluble comonomers, inorganic or organic salts, anti-foam agents or additives that themselves constitute an emulsion or a dispersion. In practice, good results are obtained with aqueous emulsions in which the polymer particles can have a diameter less than or equal to 10 μm, preferably less than or equal to 5 μm. Particularly good results are obtained with polymer particles having a diameter less than or equal to 1 μm, preferably less than or equal to 0.75 μm and more particularly less than or equal to 0.5 μm. Polymer particles with a diameter less than or equal to 0.2 μm are particularly suitable. The polymer particles can have a diameter greater than or equal to 0.05 μm. Particles with a diameter greater than or equal to 0.07 μm are preferred.

The suspension polymerization technique is a well-known technique for the production of polymers (PVDC and vinylidene chloride copolymers, Techniques de l'Ingénieur, Traité Génie des procédés, J. 6570). It is commonly used for producing vinyl polymers, especially polyvinyl chloride, polyvinylidene chloride and copolymers of vinyl chloride and vinylidene chloride. The aqueous polymer suspension used in this technique denotes a suspension of the said polymer in water or an aqueous solution. The suspension can contain additives commonly used in the production of synthetic resins by the suspension polymerization technique. Additives normally used comprise stabilizers, surface-active agents, polymerization initiators and plasticizers.

The diameter of polymer particles is linked to several parameters, in particular the polymer used, the polymerization initiator, the surface-active agents used, the dispersing agents, both as regards chemical nature as well as quantity, temperature and stirring. In practice, good results are obtained with aqueous suspensions in which the polymer particles can have a diameter less than or equal to 750 μm, preferably less than or equal to 500 μm. Polymer particles with a diameter of less than or equal to 300 μm are particularly suitable. The polymer particles can have a diameter greater than or equal to 10 μm and more particularly greater than or equal to 50 μm. Polymer particles with a diameter greater than or equal to 80 μm are particularly preferred.

The resins can be isolated by any known technique, such as for example filtration, centrifugal dewatering, vacuum-drum dewatering, screening or centrifuging. Techniques using dewatering are preferred.

The inorganic substance used in the composition according to the invention can be any mineral material. This material can be a metal carbonate, silica, clays, aluminium oxides, magnesium silicate, talcs, zeolites, metal particles, glass particles as well as mixtures of at least two of these.

Alkaline earth carbonates are preferred. Calcium and magnesium carbonates are particularly preferred. Calcium carbonate is more particularly preferred. This may be a natural or synthetic calcium carbonate. Natural calcium carbonate may be natural calcite or aragonite, chalk or marble. It may be previously ground dry or in a suspension. Synthetic calcium carbonate is preferred. Synthetic calcium carbonate can be obtained by any means. Among these means, consideration may be given to the precipitation of calcium carbonate by carbon dioxide starting with milk of lime (carbonation method) or precipitation by adding an alkali metal carbonate starting with milk of lime (caustification method) or precipitation by the addition of an alkali metal carbonate starting with solutions containing calcium chloride.

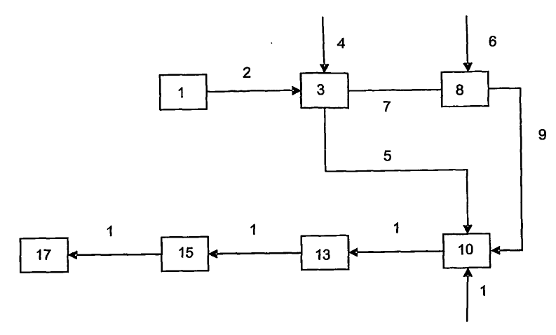

According to a preferred method within the context of the invention, the inorganic substance is calcium carbonate precipitated by the carbonation of milk of lime. This preferred method is represented in FIG. 1. Limestone from vessel (1) is fed into vessel (3) (kiln) via line (2). Fuel and combustive are fed into vessel (3) via line (4). In vessel (3), limestone is converted into quick lime (CaO) and carbon dioxide. Carbon dioxide leaves vessel (3) via line (5) and enters into vessel (10) (carbonator). Quick lime leaves vessel (3) via line (7) and enters into vessel (8) (hydrator). Water is injected into vessel (8) via line (6). In vessel (8), quick lime is converted into calcium hydroxide (Ca(OH)₂) by reaction with water. The suspension of calcium hydroxide (milk of lime) leaves vessel (8) via line (9) and enters vessel (10) (carbonator). In vessel (10), calcium hydroxide is converted into calcium carbonate by reaction with carbon dioxide. Additives can be introduced into vessel (10) via line (11). The suspension of calcium carbonate possibly containing the additives, leaves vessel (10) via line (12) and enters into vessel (13) where filtration, drying and grinding steps are carried out. Calcium carbonate so treated leaves vessel (13) via line (14) and enters vessel (15) (storage) before being fed to packing sector (17) via line (16).

According to means that are particularly preferred within the context of the invention, calcium carbonate is precipitated by carbonation of milk of lime with a gas containing carbon dioxide. In this preferred means, milk of lime is generally obtained by dispersing quick lime in fine particles in water and the gas containing carbon dioxide is advantageously a rich gas, particularly a lime kiln gas.

The calcium carbonate precipitated in this way can optionally be isolated from the preparation medium by any known technique, such as filtration, atomization and centrifuging. Techniques by filtration and centrifuging are preferred.

The inorganic substance can be substantially amorphous or substantially crystalline. Substantially amorphous or crystalline is understood to mean that more than 50% by weight of the substance is in the form of amorphous or crystalline material when analysed by an X-ray diffraction technique. Substantially crystalline substances are preferred. In the case where the inorganic substance is calcium carbonate, it can consist of calcite or aragonite or a mixture of these two crystalline phases. The calcite phase is preferred.

The efficiency of the method according to the invention is influenced by the dimensions of the particles of inorganic substance. In theory, the efficiency of the method and the quality of the composition obtained from the method should be better the finer the particle size of the inorganic substance.

According to the invention, a particle size is recommended for the inorganic substance characterized by a mean particle diameter of less than or equal to 1 μm. Particles with a diameter of less than or equal to 100 nm are especially advantageous, diameters less than or equal to 50 nm being preferred. Particles with a diameter greater than or equal to 15 nm are particularly suitable. The mean diameter of the particle is measured by the Léa and Nurse method (NF 11601/11602 standard).

According to the invention, a specific surface area is recommended for the inorganic substance that is greater than or equal to 15 m²/g. The specific surface area of particles of the inorganic substance is advantageously greater than 50 m²/g. A specific surface area greater than or equal to 70 m²/g is particularly recommended. The specific surface area of particles of the inorganic substance is generally less than or equal to 100 m²/g, values of the specific surface area less than or equal to 90 m²/g being particularly preferred. The specific surface area is measured by the standard BET method (ISO 9277 standard, 1995-05-15).

In addition to its particle size, the morphology of the inorganic substance also proves to be an important parameter in the quality and properties of the composition obtained. In the case where the inorganic substance is synthetic calcium carbonate, the particles can have the form of needles, scalenohedra, rhombohedra, spheres, platelets or prisms. A rhombohedric shape, that can be reduced to pseudo-cubes or pseudo-spheres, is preferred.

In the case where the inorganic substance is calcium carbonate, noteworthy results have been obtained with varieties of calcium carbonate of nanoscale structure—nano-faggots, nano-rosaries and nano-accordions—obtained by means of the method described and claimed in patent application WO 03004414. The definitions of nano-faggots, nano-rosaries and nano-accordions are given in document WO 03004414, page 5, line 33 to page 7, line 9 and are incorporated here for reference.

In the case where the inorganic substance is calcium carbonate, noteworthy results have also been recorded with microspherical entities, possibly hollow, that can be obtained by atomization.

The surface-active agent can be selected from alkyl sulphates, aryl sulphonates, alkyl sulphosuccinates and mixtures of at least two of these.

Alkyl sulphates are understood as denoting compounds of the group consisting of alkyl sulphuric acids, corresponding salts and mixtures of at least two of these.

The term alkyl represents a linear or branched aliphatic hydrocarbon group having a number of carbon atoms greater than or equal to one. This number of carbon atoms is preferably greater than or equal to 6. A number of carbon atoms greater than or equal to 10 is very suitable. This number is usually less than or equal to 20 and more specifically less than or equal to 16. Sodium, potassium or ammonium lauryl sulphates are preferred. Sodium lauryl sulphate is particularly preferred.

Arylsulphonates are understood as denoting compounds of the group consisting of aryl sulphonic or alkylaryl sulphonic acids or the corresponding salts and mixtures of at least two of these.

The term aryl represents a mono- or bicyclic aromatic hydrocarbon group having at least 6 carbon atoms and no more than 10 carbon atoms, such as phenyl and naphthyl groups.

The term alkylaryl represents an alkyl radical as defined above linked covalently to an aryl residue as defined above.

In a preferred procedure, the surface-active agent can be selected from compounds represented by the following general formulae: 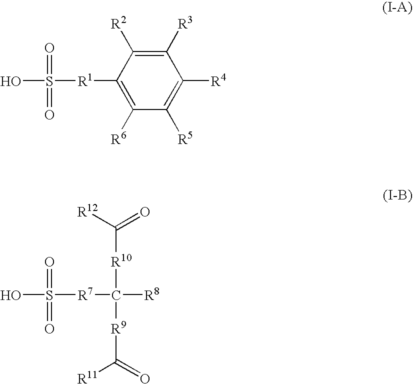
where R¹, R⁷, R⁹ and R¹⁰ are independently a single bond, —O—, a —C₁-C₁₈-alkylene group or a —C₂-C₁₈-alkenylene group (where in the alkylene or alkenylene chain, 1, 2 or 3 —CH₂— groups may be optionally replaced by —O—);
R², R³, R⁴, R⁵ and R⁶ are independently —H, a —C₁-C₁₈-alkyl group (where in the alkyl chain, 1, 2 or 3 —CH₂— groups may be optionally replaced by —O—), —OH, —F, —Cl, —CN, —CO₂H, —CO—C₁-C₆-alkyl, —CO₂—C₁-C₆-alkyl, —O—CO—C₁-C₆-alkyl, —NO₂, —NH₂, —NH—C₁-C₆-alkyl or —N(C₁-C₆-alkyl)₂;
R⁸ is —H or C₁-C₆-alkyl; and
R¹¹ and R¹² are independently —H, a —C₁-C₁₈-alkyl group (where in the alkyl chain, 1, 2 or 3 —CH₂— groups may be optionally replaced by —O—), —NH₂, —NH—C₁-C₆-alkyl or —N(C₁-C₆-alkyl)₂.

The term “alkylene” is understood to mean divalent linear or branched chains such as —CH₂—, —CH₂CH₂—, —CH₂CH₂CH₂—, —CH₂CH₂CH₂CH₂—, —CH(CH₃)—, —CH₂CH(CH₃)—, —CH₂CH₂CH(CH₃)—, —CH═C(CH₃)CH₂— and the like.

The term “alkenylene” is understood to mean divalent linear or branched chains such as —CH═CH—, —CH₂CH═CH—, —CH₂CH₂CH═CH—, —CH═C(CH₃)—, —CH₂CH═C(CH₃)—, —CH═C(CH₃)CH₂— and the like.

In a preferred manner, in compounds represented by the general formulae (I-A) and (I-B):
R¹, R⁷, R⁹ and R¹⁰ are independently a single bond or a —C₁-C₆-alkylene group (where in the alkylene chain, 1, 2 or 3 —CH₂— groups may be optionally replaced by —O—);
R², R³, R⁴, R⁵ and R⁶ are independently —H or a —C₁-C₁₈-alkyl group (where in the allyl chain, 1, 2 or 3 —CH₂— groups may be optionally replaced by —O—);
R⁸ is —H or C₁-C₆-allyl; and
R¹¹ and R¹² are independently a —C₁-C₁₂-alkyl group (where in the alkyl chain, 1, 2 or 3 —CH₂— groups may be optionally replaced by —O—).

In a particularly preferred manner:
R¹ and R⁷ are single bonds
R², R³, R⁵ and R⁶ are —H
R⁴ is —H or a —C₁-C₁₈-allyl group
R⁸ is —H
R⁹ and R¹⁰ are independently a single bond or —CH₂— and
R¹¹ and R¹² are independently a —C₁-C₁₂-alkoxy group.

The term “alkoxy” denotes an alkyl residue as defined above covalently bonded to an oxygen atom, such as —OCH₃, —OCH₂CH₃ and the like.

Among arylsulphonates, sodium dodecylbenzenesulphonate is particularly preferred.

Among alkylsulphosuccinates, sodium dioctylsulphosuccinate is particularly preferred.

The surface-active agent content of the filler is generally greater than or equal to 0.1% by weight, preferably greater than or equal to 0.5% by weight and more particularly greater than or equal to 1% by weight. This content is normally less than or equal to 20% by weight and more specifically less than or equal to 15% by weight A content less than or equal to 5% by weight is particularly suitable.

The coating agent can be selected from saturated or unsaturated fatty acids, corresponding salts or any mixture of at least two of these. The fatty acids have a number of carbon atoms generally greater than or equal to 6, preferably greater than or equal to 12 and more particularly greater than or equal to 14. This number of carbon atoms is normally less than or equal to 26 and more particularly less than or equal to 22. A number of carbon atoms less than or equal to 18 is particularly suitable. Mixtures containing stearic, palmitic and oleic acid are particularly preferred. Such mixtures are also called “stearin” and are commercially available under the tradenames Priplus, Edenor, Pristerene, Undesa, Prifac, Radiacid, Safacid, Cremer among others. Such a mixture, for example, so called technical grade stearic acid contains about 60-65 wt.-% stearic acid and about 40-35 wt.-% palmitic acid, the balance being mainly oleic acid.

The coating agent content of the filler is generally greater than or equal to 0.5% by weight, preferably greater than or equal to 1% by weight and more particularly greater than or equal to 2.5% by weight. This content is normally less than or equal to 25% by weight and more particularly less than or equal to 20% by weight. A content less than or equal to 15% by weight is.particularly suitable.

The filler content of the composition can be greater than or equal to 0.5% by weight. This content is preferably greater than or equal to 1% by weight and more particularly greater than or equal to 2% by weight. This content is normally less than or equal to 10% by weight, more specifically less than or equal to 5% by weight. A content of less than or equal to 3% by weight is particularly suitable.

The composition according to the invention can be obtained by various methods. As a consequence, the invention therefore also relates to a method for producing a composition containing at least one synthetic resin and at least one filler, according to which a polymer is prepared and at least one filler is added thereto, the filler containing (a) at least one inorganic substance having a specific surface area higher than or equal to 15 m²/g and (b) at least one surface-active agent and/or at least one coating agent.

In the method according to the invention, the synthetic resin can be used in the form of a solid or an aqueous emulsion or an aqueous suspension. It is preferred to use the synthetic resin in the form of a solid or an aqueous emulsion.

A solid synthetic resin is understood to mean resins isolated from the polymerization medium by any known technique, for example filtration, centrifuging, spraying, or atomizing, it being possible for these operations to be preceded by a coagulation step. The solid can contain compounds other than the polymer itself, such as for example one or more additives used during the polymerization step. The water content of the solid can be less than or equal to 1.5% by weight. This content is preferably less than or equal to 0.8% by weight and more particularly less than or equal to 0.3% by weight.

An aqueous emulsion of the resin is understood to mean the aqueous phase obtained from the emulsion polymerization procedure such as described above.

An aqueous suspension of the resin is understood to mean the aqueous phase obtained from the suspension polymerization procedure such as described above.

In the method according to the invention, the filler containing the inorganic substance and the surface-active agent or the coating agent can be formed as a dry solid or a moist cake or an aqueous slurry. Application in the dry solid state or in the aqueous slurry state are preferred.

A dry solid is understood to mean the solid filler isolated from its preparation medium as described above and of which the water content can be less than or equal to 10% by weight. This content is preferably less than or equal to 5% by weight and more particularly less than or equal to 3% by weight. A content of less than is equal to 1% by weight is particularly suitable.

A moist cake is understood to mean the solid filler isolated from its preparation medium as described above and of which the water content can be less than or equal to 70% by weight. This content is preferably less than or equal 50% by weight. This water content is normally greater than or equal to 10% by weight, more specifically greater than or equal to 30% by weight.

An aqueous slurry is understood to mean an aqueous suspension of solid matter that can be pumped as distinct from a moist filter cake. In the method according to the invention, the optimum content of the filler for producing a stable slurry will depend on several factors, in particular the working temperature and the particle size of the inorganic substance. In general, the concentration of the inorganic substance in the slurry can be greater than or equal to 30 g/l and preferably greater than or equal to 180 g/l. This concentration is generally less than or equal to 250 g/l, more specifically less than or equal to 180 g/l.

The surface-active agent that the filler contains, can be employed in the form of a solid or a solution or an emulsion or a suspension. It is preferably used in the form of a solution or an emulsion. It is possible to introduce the surface active agent in the preparation medium of the filler. The surface-active agent is preferably introduced in the form of a solution or an emulsion.

The coating agent that the filler contains can be employed in the form of a solid or a liquid or a solution or an emulsion or a suspension. It is preferred to use it in the form of an emulsion or a molten solid. It can be introduced into the medium for preparing the filler. The coating agent is preferably introduced in the form of an emulsion or a solid.

According to a first variant according to the invention, the polymer is isolated in the form of a solid, the filler is added thereto in the form of a dry solid and the blend is mixed substantially in the absence of liquid. Substantially in the absence of liquid is understood to mean that the liquid content in the mixture is generally less than or equal to 15 g/kg of mixture, preferably less than or equal to 8 g/kg and more particularly less than or equal to 3 g/kg. It is preferred to add the filler containing an inorganic substance and a coating agent. It is more particularly preferred to add the filler containing an inorganic substance and stearin.

Mixing is carried out by any type of known means. Mixing in a mixer of the slow-speed, high-speed or planetary type or in an extruder of the single-screw or twin-screw type is preferred. Mixing in a slow-speed mixer is more particularly preferred.

According to a second variant according to the invention, an aqueous emulsion of the polymer is prepared and the filler is added thereto and the emulsion is coagulated.

The filler can be added in the form of a dry solid, a moist cake or an aqueous slurry. Addition of the filler in the form of an aqueous slurry is preferred.

Coagulation of the aqueous emulsion consists of breaking the colloidal stability of the emulsion by bringing about the coagulation of polymer particles that settle as they agglomerate into entities that are between 10 and 1200 μm in size. Various means are known to bring about coagulation of the emulsion. A preferred means consists of adding a coagulating agent to the emulsion. This is generally a suitable metal salt, for example an aluminium salt. The concentration of coagulating agent in the mixture of the aqueous emulsion and the aqueous slurry of the filler can be less than or equal to 5% by weight, preferably less than or equal to 2% by weight and more particularly less than or equal to 1.5% by weight. This concentration is generally greater than or equal to 0.05% by weight and more specifically greater than or equal to 0.10% by weight. A concentration greater than or equal to 0.15% by weight is particularly suitable.

The composition collected following coagulation is normally subjected to drying before being stored for subsequent use.

All other things being equal, in the method according to the invention, the quality and properties of the composition obtained following coagulation will depend on a combination of several parameters, among which the content of polymer in the emulsion, the concentration of filler in the slurry and the quantity of slurry used.

In an advantageous embodiment of the method according to the invention, the polymer emulsion contains at least 30 g/l and it contains no more than 450 g/l polymer, and in a preferred manner no more than 250 g/l polymer, the slurry contains at least 25 g and no more than 250 g of filler per kg of aqueous suspension and the slurry is used in a sufficient quantity for the composition generally to contain at least 0.5% of filler by weight, preferably at least 1% by weight and more particularly at least 2% by weight, and for the composition to contain no more than 10% of filler by weight, more specifically no more than 5% by weight and more particularly no more than 3% by weight.

All other things being equal, in addition, in the case of the production of compositions containing polyvinylidene chloride, the crystalline morphologies of calcium carbonate structured at the nanometric scale such as described above make possible an optimum incorporation efficiency in the composition. Incorporation efficiency is understood to mean the ratio of the mass of calcium carbonate actually incorporated into the composition to that employed in the slurry.

As stated above, the slurry of the filler used in the method according to the invention contains an inorganic substance and a surface-active agent and/or a coating agent. Without wishing to be tied to any particular theory, it is thought that this agent has the function of facilitating the dispersion particles of the filler in the polymer emulsion. It has however been observed that the choice of agent can have an influence on the properties of the composition and on those of products produced with this composition. In particular, in the case of compositions containing polyvinylidene chloride, an unsuitable choice for the agent can have a negative influence on the properties of sheets produced with the composition, particularly on their thermal resistance and on their impermeability to oxygen in the air.

Consequently, in an advantageous embodiment of the method according to the invention, when the inorganic substance is precipitated calcium carbonate, the slurry contains a surface-active agent that is an ionic compound. This compound is preferably compatible with the emulsion to which the slurry is added. In the case where the resin contains polyvinylidene chloride, the surface-active agent is advantageously selected from arylsulphonates, alkyl sulphosuccinates, alkyl sulphates and mixtures of at least two of these.

Compositions obtained according to the invention have noteworthy properties, superior to those of known compositions. These noteworthy properties can be particularly seen for compositions comprising vinylidene chloride, relating in particular to better extrudability by virtue of better uniformity of the dispersion of calcium carbonate in the composition and improved porosity. The porosity of the composition is favourable on the one hand to rapid drying in the coagulation method and on the other hand makes possible improved adsorption of additives during subsequent treatment in an extruder. Moreover, the films obtained, in spite of the increase in porosity measured on the compositions, keep their good oxygen-barrier properties, by virtue of the noteworthy uniformity of the dispersion obtained. They also have a better visual appearance. These properties make them particularly well suited to use in the food industry. The films obtained also have a feel that is particularly suitable for medical applications.

The invention consequently also relates to the use of compositions according to the invention for the production of films. In a preferred manner, those films can be obtained by blown-film extrusion.

The invention consequently also relates to films obtained starting with compositions according to the invention.

The examples, of which the description follows, serve to illustrate the invention without however limiting the scope of the following Claims.

Method for Preparing a Solid Polymer by the Emulsion Polymerization Method

An enamelled autoclave (AC) having a volume of 67 litres was provided with a 12-litre capacity jacket the temperature of which was regulated by introducing steam at 3 bar and water through two regulating valves operating according to the temperature measured in the reaction mixture, and
12 litres of demineralized water were introduced,
2.26 mol of sodium dodecylbenzenesulphonate were introduced,
4 g of ascorbic acid were introduced,
vacuum was applied to 140 mbar absolute over 10 minutes,
the autoclave was pressurized by introducing nitrogen to a relative pressure of 0.5 bar for 10 minutes,
vacuum was applied to 140 mbar absolute,
   while regulating the temperature of the jacket of the vessel to 15° C.:
8 kg of unstabilized vinylidene chloride (purity=at least 99.97%) and
2 kg of vinyl chloride were introduced.

The reaction mixture was stirred at 40 rpm by means of a stirrer of the Impeller 3C type. At the same time, the reaction mixture was brought to a temperature of 43° C. Hydrogen peroxide (0.7 g) was introduced when the temperature reached 41° C.

After 30 minutes, a 5 g/l hydrogen peroxide solution and a 20 g/l ascorbic acid solution were added at the same time so as to maintain a temperature difference between the internal temperature of the autoclave and that of the jacket between 13 and 25° C. After at least 1 hour and not more than 12 hours of polymerization, injection of hydrogen peroxide was stopped when the pressure in the AC fell by at least 0.35 bar and the introduction of hydrogen peroxide was stopped when the fall in pressure reached 0.55 bar.

The reaction mixture was then heated to 50° C. and the AC was put under vacuum so as to remove residual monomers in order to give a level compatible with its use in food applications. Stirring was reduced to 20 rpm during this step. The reaction mixture was then cooled to 25° C.

The polymer was isolated from the reaction mixture by means of a coagulation step. For 3 litres of reaction mixture, the operating procedure was as follows:
A coagulating solution was added to cover the bottom of a vessel whose temperature was maintained by means of a waterbath. This 1-litre volume contained a concentration of 0.17 g of aluminium nitrate. The temperature was maintained between 10° C. and 14° C. according to the final particle size aimed at. The reaction mixture and the remainder of the coagulating solution were added simultaneously over the same period while maintaining the temperature and while stirring continuously at 125 rpm using a curved blade stirrer with six blades. This corresponded to:
31 of reaction mixture at a concentration of 200 g/l,
1 litre of a 0.34 g/l solution of aluminium nitrate.

This double addition was carried out over 30 min taking care to place the inlets for reaction mixture and coagulating solution diametrically opposite each other in the coagulating vessel. Once this step was completed and after having verified the quality of the coagulation, a thermal treatment step was carried out by bringing the resin to 70° C. over 90 minutes. The resin was then cooled to 30° C. before being drained on a Büchner funnel under vacuum. The resin was taken up twice in 2 L of demineralized water so that it could be completely rinsed and drained each time on the Büchner funnel. At the end of this third draining under vacuum, the cake was introduced into the bowl of a small Retsch-brand fluidized bed drier and then dried by passing air at 30° C. After 2 hours, the resin was dry and had a volatile matter (water) content below 0.3% on a weight/weight basis.

Method for Preparing a Solid Polymer by the Suspension Polmerization Method

An enamelled autoclave (AC) having a volume of 67 litres was provided with a 12-litre capacity jacket the temperature of which was regulated by introducing steam at 3 bar and water through two regulating valves operating according to the temperature measured in the reaction mixture, and
17 litres of demineralized water were introduced,
lauroyl peroxide flakes (100 g) were introduced,
30 g of a dispersant of the methylpropoxycellulose type, such as Culminal C3550, were introduced, prepared in demineralized water to give a concentration of 10 g/l,
vacuum was applied to 140 mbar absolute over 10 minutes,
the autoclave (AC) was pressurized by introducing nitrogen to a relative pressure of 0.5 bar for 10 minutes,
vacuum was applied to 140 mbar absolute,
   while regulating the temperature of the jacket of the vessel to 15° C.:
9 kg of unstabilized vinylidene chloride (purity=at least 99.97%) and
1 kg of methyl acrylate were introduced.

The reaction mixture was stirred at 40 rpm by means of a stirrer of the Impeller 2B type. At the same time, the reaction mixture was brought to a temperature of 75° C. When the reaction had finished, the temperature difference between the jacket and the reaction mixture was reduced until it became less than 2° C., and 15 minutes were allowed to elapse before the reaction mixture was cooled Once the resin had been obtained, a step was carried out to remove residual monomers by stripping : the slurry, a mixture of water and resin, was brought to 100° C. by heating and a vacuum was created in the autoclave. After 2 hours stripping, the reaction mixture was cooled by introducing water into the jacket and was drained on a filter on a Büchner funnel under vacuum. The resin was taken up twice in 2 litres of demineralized water so that it could be completely rinsed and drained each time on the Büchner funnel. At the end of this third draining under vacuum, the cake was introduced into the bowl of a small Retsch-brand fluidized bed drier and then dried by passing air at 30° C. After 2 hours, the resin was dry and had a volatile matter (water) content below 0.3% on a weight/weight basis.

Procedure for Preparing a Dry Uncoated Precipitated Calcium Carbonate (PCC)

A stream of carbonic gas containing 30% by volume of CO₂ was introduced into a 40-litre reactor containing milk of lime with a lime concentration of 180 g/l, at a temperature of 20° C. and at a flow rate of 16 m³/h. After approximately 90 minutes, 100% of the calcium hydroxide had been converted into calcium carbonate. The PCC was recovered by filtration and was dried at around 105° C. and the solid was then ground in an Alpine-type grinder. The solid had a specific surface area of approximately 20 m²/g.

Proceeding in the same way in the presence of varying quantities of citric acid in the reaction mixture, solids were obtained having a specific surface area of approximately 66 m²/g or approximately 80 m²/g.

Procedure for Preparing a Dry Coated PCC

A stream of carbonic gas containing 30% by volume of CO₂ was introduced into a 40-litre reactor containing lime water with a lime concentration of 180 g/l, at a temperature of 20° C. and at a flow rate of 16 m³/h. After approximately 90 minutes, 100% of the calcium hydroxide had been converted into calcium carbonate. The suspension of PCC obtained was brought to approximately 80° C. and an aqueous emulsion of stearin, also brought to 80° C., was then added. The stearin content of the emulsion was calculated so as to obtain a content of approximately 3 to 12% by weight based on the dry calcium carbonate. The system was stirred for approximately 30 minutes before being filtered, then dried at 105° C. and finally ground. The aqueous emulsion of stearin could have been replaced by a solution of sodium dodecylbenzenesulphonate, the concentration of this being calculated to obtain a content of approximately 1 to 4% by weight based on dry calcium carbonate.

Procedure for Producing Films

The resin was premixed first of all in the presence of various additives such as a plasticizer, liquid heat stabilizers and a wax. This premix was then introduced into an extruder fitted with a parison. The tubular parison collected from the extruder heated to 150° C. was converted into a film by blowing.

Before extrusion
4% by weight of dibutyl sebacate;
1.2% epoxidized soya oil
could have been mixed in at 70° C.
   Methods for Analysing the Properties of Resins and Films
   Incorporation Efficiency

The incorporation efficiency (IE) of calcium carbonate in the composition, expressed in percentage by weight of calcium carbonate (in the dry state) used (in the dry state or in the slurry).

The incorporation efficiency was calculated by determining the calcium content of the mixture by dissolving the resin in an aliquot of tetrahydrofuran heated to 60° C. then adding an aqueous solution of hydrochloric acid. The aqueous phase obtained was separated by filtration and then analysed by ICP-AES or by colorimetry.

DOP Porosity

The DOP porosity was measured by adsorption of a plasticizer (dioctyl phthalate) in the pores of the composition. The ability of the composition to adsorb a plasticizer and to undergo extrusion is proportional to the DOP porosity. A known mass aliquot of the composition was placed in contact with the same quantity of dioctylphthalate. After a contact time of 30 minutes at ambient temperature, the whole was placed in a filter cartridge of which the filtration threshold retained the polymer particles. Filtration was carried out by centrifuging (30 seconds) and the quantity of DOP recovered was weighed and the porosity given corresponded to the percentage of DOP incorporated in the resin in relation to the quantity used in the initial mixture.

FFD or Free Flow Density

This involved placing a mass of 250 g of resin in a cylinder at a height and closed by a pivoting disc. A cylinder with a known volume was placed under this tube and acted as a receiver for the resin which flowed under gravity when the disc stopper was moved to one side. The resin surplus was scraped off by passing a rule resting on the edge of the receiving test tube. The mass of resin contained was then weighed and the FFD deduced from the ratio of the mass of resin/volume of receiving test tube.

Particle Size Distribution

In the case of the resin emulsion, the particle size distribution was obtained by screening the resin through a series of screens of which the thresholds were, from the coarsest to the finest, 850 μm, 500 μm, 350 μm, 250 μm, 104 μm and 44 μm.

For the resin suspension, which had spherical particles, it was light scattering that was used employing-an-apparatus of the Malvern or Coulter brand. A curve was obtained from which it was possible to extract d₁₀, d₅₀ and d₉₀ data. d₁₀ for example is understood as giving the necessary diameter for a screen that would only allow 10% of the mass of resin to pass. The mean diameter is called d₅₀. The distribution is given by the data of the span that corresponds to the index obtained according to the ratio (d₉₀-d₁₀)/d₅₀.

The particle size distribution of the composition resulting from the second variant according to the invention was determined by the screening method as described above. The mean diameter dₘ, the diameter d₅₀ and the particle size spread [symbol] of the composition were also calculated, these three parameters being defined by the equations:

$$\begin{matrix}{d}_{m} = \frac{\sum {n}_{i} {d}_{i}}{n} \\ η = \frac{{d}_{90} - {d}_{10}}{{d}_{50}}\end{matrix}$$

where
nᵢ denotes the weight of particles of diameter dᵢ;
n denotes the total weight of the composition (=Σnᵢ);
d₉₀ denotes the diameter of the screen through which 90% of the weight of the composition passes;
d₁₀ denotes the diameter of the screen through which 10% of the weight of the composition passes; and
d₅₀ denotes the diameter of the screen through which 50% of the weight of the composition passes.
   Thermal Stability

The thermal stability (TS) was measured at 160° C. in a twin-cam mixer (one master and one slave) of the Brabender brand. Changes in the colour of the mix and of the torque to which the slave cam was subjected were recorded. The thermal stability, which was measured in minutes, corresponded to the period necessary for a break to be observed in the decreasing slope of the torque, a break that revealed a three-dimensional reorganization of the product and therefore irreversible degradation before it charred.

Oxygen Permeability

Once a film was obtained, its thickness was measured by light diffraction (infrared spectroscopy). The film was then hermetically placed on the upper side of a cell included in a double network. A stream of pure oxygen circulated below and a stream of nitrogen circulated above, which entrained the oxygen that had migrated through the film. This oxygen was then analysed coulometrically and the quantity that had migrated during 24 h, apart from a transient period, was multiplied by the film thickness in microns so as to define the intrinsic permeability in g of oxygen/day.μm, and this at 25° C. and 85% humidity (ASTM standard D-3985-81).

First Variant According to the Invention

In each example, the solid polymer has been obtained from suspension polymerization according to the procedure previously detailed. The solid polymer and the filler were mixed by the following procedure.

500 g of polymer in powdered form were placed in a slow premixer having a 1 kg capacity and provided with a system for maintaining the temperature of the mixture. This resin was stirred for 30 minutes so as to bring its temperature to 50° C. and then 7.5 g of dry filler (precipitated calcium carbonate, PCC) were added and stirring was carried out continuously while maintaining the temperature for 6 hours. Once mixing was complete, care was taken when transferring the product to screen out hard agglomerates that may have formed essentially on the blades of the mixer. Epoxidized soya oil (ESO, Edenol® D82) could optionally have been added to the preceding compounds before mixing.

The composition resulting from the mixture was then used to produce films according to the procedure described below.

### EXAMPLE 1

### Not According to the Invention

The composition resulting from the mixture did not contain epoxidized soya oil or filler.

### EXAMPLE 2

### Not According to the Invention

The composition resulting from the mixture only contained epoxidized soya oil.

### EXAMPLE 3

### According to the Invention

The resin was mixed with epoxidized soya oil and a filler containing precipitated calcium carbonate having a specific surface area of approximately 80 m²/g and 12% by weight (vs PCC) of stearin as a coating agent.

### EXAMPLE 4

### According to the Invention

The resin was mixed with epoxidized soya oil and filler containing precipitated calcium carbonate having a specific surface area of approximately 20 m²/g and containing 3% by weight (vs PCC) of stearin as a coating agent.

### EXAMPLE 5

### According to the Invention

The resin was mixed with epoxidized soya oil and a filler containing precipitated calcium carbonate having a specific surface area of approximately 66 m²/g and containing 9.9% by weight (vs PCC) of sodium dodecylbenzenesulphonate as a surface-active agent.

### EXAMPLE 6

### According to the Invention

The resin was mixed with a filler containing precipitated calcium carbonate having a specific surface area of approximately 66 m²/g and containing 3.3% by weight (vs PCC) of sodium dodecylbenzenesulphonate as a coating agent.

### EXAMPLE 7

### According to the Invention

The resin was mixed with a filler containing precipitated calcium carbonate having a specific surface area of approximately 20 m²/g and containing 12% by weight (vs PCC) of stearin as a coating agent.

Table 1 gives the concentrations of different components of the mixtures (in % by weight) as well as the properties of the compositions resulting from the mixtures and the films obtained starting from these compositions.

TABLE 1

| | Example | | | | | | |
|---|---|---|---|---|---|---|---|
| | 1 | 2 | 3 | 4 | 5 | 6 | 7 |
| Resin (%) | 100 | 100 | 100 | 100 | 100 | 100 | 100 |
| ESO (%) | | 2 | 2 | 2 | 1 | | |
| PCC (%) | | | 1 | 1 | 1 | 2 | 2 |
| Film | (c) | (a) | (a) | (b) | — | — | (a) |
| appearance | | | | | | | |
| TS (min) | — | 11 | 26 | 18 | 24 | 30 | >20 |
| O₂ | 10 | 7.8 | 7.6 | 9.5 | — | — | 4.4 |
| permeability | | | | | | | |
| (cm³ · 10 μm/m²/ | | | | | | | |
| day/bar) | | | | | | | |

Film appearance:
(a) normal,
(b) translucent,
(c) wavy.

Second Variant of the Invention

In each example, an aqueous emulsion of polyvinylidene chloride was prepared in demineralized water by the emulsion polymerization technique according to the procedure previously detailed. The emulsion obtained contained 200 g of resin (weight of dry matter) per litre.

At the same time, a slurry of calcium carbonate was prepared comprising 100 g of calcium carbonate (weight of dry matter) per litre according to the procedure previously detailed.

0.2 g of an aluminium salt (coagulating agent) per litre was then added to the emulsion and the quantity of slurry adjusted so that the emulsion contained a quantity of calcium carbonate substantially equal to 2.5% by weight of dry matter. The mixture was maintained at a temperature of 13° C. for a time necessary to obtain complete coagulation of the latex. The composition collected following coagulation was then subjected to heat treatment for 90 min at 70° C. The composition was then washed with demineralized water and then dried by fluidization in ambient air at 60° C.

The composition obtained was then analysed for the following parameters:
incorporation efficiency (IE)
DOP porosity
free-flow density (abbreviated to FFD)
particle size distribution of the composition
thermal stability (TS) of the composition.

The composition was also subjected to a blown-film extrusion test in order to measure its oxygen permeability. Before extrusion, the following were added to the composition with mixing at 70°:
4% by weight of dibutyl sebacate;
1.2% of epoxidized soya oil.

### EXAMPLE 8

### Not According to the Invention

In this example, the resin was coagulated in the absence of calcium carbonate.

### EXAMPLE 9

### According to the Invention

Calcium carbonate was used having an ultrafine morphology, a mean diameter of 15 nm and a specific surface area of the order of 80 m²/g, and sodium dodecylbenzenesulphonate was introduced into the aqueous slurry as a surface-active agent.

### EXAMPLE 10

### According to the Invention

The same calcium carbonate was used as in Example 1 but sodium lauryl sulphate was introduced into the aqueous slurry as a surface-active agent.

### EXAMPLE 11

### According to the Invention

Calcium carbonate was used, structured at the nanometric scale, obtained according to the method described in application WO 03/004414 having a specific surface area of 25 m²/g, containing sodium dodecylbenzenesulphonate previously introduced into the aqueous slurry.

### EXAMPLE 12

### According to the Invention

Calcium carbonate, structured at the nanometric scale, was used having a microspherical structure containing sodium dodecylbenzenesulphonate previously introduced into the aqueous slurry.

The results of the tests are given in Table 2 below.

TABLE 2

| | Example | | | | |
|---|---|---|---|---|---|
| | 8 | 9 | 10 | 11 | 12 |
| IE (%) | — | 56 | 54 | 70 | 56 |
| DOP porosity | 15 | 41 | 40.5 | — | — |
| FFD | 0.65 | 0.56 | 0.63 | 0.49 | 0.58 |
| >850 μm/g | 116 | 62 | 74 | 147 | 86 |
| 850-500 μm/g | 219 | 93 | 84 | 109 | 71 |
| 500-250 μm/g | 259 | 104 | 98 | 116 | 83 |
| 250-104 μm/g | 204 | 147 | 218 | 560 | 218 |
| 104-45 μm/g | 114 | 377 | 358 | 4 | 481 |
| <45 μm/g | 88 | 217 | 168 | 64 | 61 |
| dₘ (μm) | 450 | 250 | 270 | 430 | 278 |
| d₅₀ (μm) | 240 | 55 | 70 | 140 | 70 |
| η | 3 | 9 | 7 | 6 | 8 |
| TS (min) | 7 | 13 | 15 | 14 | 15 |
| O₂ permeability | 950 | 785 | 830 | 1010 | 790 |
| (cm³ · μm/m² · d · | | | | | |
| atm) | | | | | |

1. A composition comprising:
(a) at least one synthetic resin selected from the group consisting of homopolymers and copolymers of ethylene, propylene, styrene, vinyl chloride, vinylidene chloride, acrylic acid, alkyl acrylates, methacrylic acid, alkyl methacrylates, acrylonitrile, vinyl acetate, vinyl alcohol, isoprene, chloroprene, vinyl fluoride, vinylidene fluoride, tetrafluoroethylene, copolymers of ethylene and alpha-olefins, copolymers of propylene and alpha-olefins other than propylene, copolymers of vinylidene chloride and vinyl chloride, copolymers of vinylidene chloride and alkyl acrylates, copolymers of vinylidene chloride and alkyl methacrylates, copolymers of styrene, butadiene and rubber, copolymers of acrylonitrile and butadiene, copolymers of styrene and acrylonitrile, copolymers of acrylonitrile, butadiene and styrene, copolymers of vinylidene fluoride and hexafluoropropylene, polyesters, polyamides, polyurethanes, polycarbonates, polyphenylene ethers, polyimides, polyamide imides, polybenzimidazoles, polyalkylene oxides, polyetherether ketones, polyether sulfones, polyisocyanates, and polyphenylene sulfides; and
(b) at least one filler containing (b1) at least one inorganic substance having a specific surface area higher than or equal to 15 m²/g and (b2) at least one surface-active agent and/or at least one coating agent.

2. The composition according to either of claim 1, wherein the synthetic resin is a copolymer of vinylidene chloride and vinyl chloride containing at least 40% by weight of vinylidene chloride.

3. The composition according to either of claim 1, wherein the synthetic resin is a copolymer of vinylidene chloride and methyl acrylate containing at least 60% by weight of vinylidene chloride.

4. The composition according to claim 1, wherein the inorganic substance is in the state of particles with a mean diameter less than 1 μm.

5. The composition according to claim 1, wherein the concentration of the filler in the composition is greater than or equal to 0.5% by weight and is less than or equal to 10% by weight.

6. The composition according to claim 1, wherein the inorganic substance is calcium carbonate precipitated by carbonation of milk of lime.

7. The composition according to claim 1, wherein the surface-active agent is selected from the group consisting of alkyl sulphates, arylsulphonates, alkyl sulphosuccinates and mixtures of at least two of these.

8. The composition according to claim 1, wherein the coating agent is selected from the group consisting of fatty acids having a number of carbon atoms greater than or equal to 6 and less than or equal to 26, and mixtures of at least two of these.

9. for producing a composition according to claim 1, according to which a synthetic resin is prepared and at least one filler is added thereto, the filler comprising (a) at least one inorganic substance having a specific surface area higher than or equal to 15 m²/g and (b) at least one surface-active agent and/or at least one coating agent.

10. The method according to claim 9, according to which the synthetic resin is prepared by an aqueous emulsion polymerization method or by an aqueous suspension polymerization method.

11. The method according to claim 9 according to which, following polymerization, an aqueous emulsion of the resin or an aqueous suspension of the resin is collected or the resin is isolated in the form of a solid.

12. The method according to claim 9, wherein the filler is added in the form of a solid, a moist cake or an aqueous slurry.

13. The method according to claim 11, wherein the resin is isolated in the form of a solid and the filler is added thereto in the form of a solid, substantially in the absence of liquid.

14. The method according to claim 11, wherein an aqueous emulsion of the resin is collected, the filler is added thereto in the form of an aqueous slurry and the emulsion is coagulated, by adding a coagulating agent.

15. (canceled)

16. The method according to claim 14, wherein the coagulating agent is a metal salt.

17. The method according to claim 16, wherein the metal salt is an aluminum salt.

18. A method for the production of films which comprises the use of a composition according to claim 1.

19. The method according to claim 18 for producing films by blown-film extrusion.

20. Films produced starting from a composition according to claim 1.
